(19) United States
(12) Patent Application Publication
(10) Pub. No.: US 2025/0125634 A1
(43) Pub. Date: Apr. 17, 2025

(54) ENERGY SUPPLY SYSTEM AND METHOD FOR SUPPLYING ENERGY

(71) Applicant: Siemens Energy Global GmbH & Co. KG, Erlangen (DE)

(72) Inventor: Thomas Scholz, Barnitz, Schleswig-Holstein (DE)

(21) Appl. No.: 18/686,472

(22) PCT Filed: May 17, 2022
(86) PCT No.: PCT/EP2022/063284

§ 371 Date: Feb. 26, 2024

(30) Foreign Application Priority Data
Sep. 8, 2021 (DE) 10 2021 209 915.7

(51) Int. Cl. H02J 7/00; H01M 10/44; H01M 16/00

(52) U.S. Cl. CPC H02J 7/0013; H01M 10/441; H01M 16/006; H01M 2250/402; H02J 2207/20

(57) ABSTRACT

The invention relates to an energy supply system having energy supply modules which are connected in parallel and each controlled autonomously, the energy supply modules each including load connections, a battery which couples directly to the load connections, a fuel cell which couples to the load connections via a DC/DC converter, characterized in that, within an energy supply module, the operating point of the fuel cell and the operating point of the DC/DC converter are able to be controlled by an energy management system on the basis of a state of charge of the battery, and to a method for supplying energy.

### BACKGROUND

The invention relates to an energy supply system and to a method for supplying energy.

Up to now, batteries together with fuel cells have only been used as a network supply in electrical systems in very different sizes with regard to their capacities.

Since in such cases primarily only one component supplies power to the electrical network, an energy management means is not provided.

In systems in which the electrical network is primarily supplied with power from a battery, the considerably smaller fuel cell is installed only for backup. A negative influence on the battery, e.g. due to the battery being overcharged by the fuel cell, is technically almost impossible. Owing to the small size of the fuel cell, a lot of time and gas would be required for this. An energy management means is not installed in these systems. On submarines, for example, there is a large battery which supplies power to the electrical network, and a fuel cell which is coupled to the energy supply system via a DC/DC converter. The capacity of the fuel cell is in the thousandths compared to the capacity of the battery. The fuel cell is used either for battery maintenance or in exceptional cases for concomitantly supplying power to part of the on-board electrical system. The main charging of the battery is usually done by generators since the fuel cell cannot deliver the currents required for this. The fuel cell system is typically controlled by an automation system.

Conversely, in systems in which the fuel cell virtually exclusively supplies power to the electrical network, only a small battery is installed which is provided exclusively for starting the system. After the start process, the fuel cell recharges the battery at the same time as supplying power to the system. The charging process is monitored by a simple charge controller and terminated as soon as the battery is full. Since the system is substantially only supplied with power from the fuel cell, an energy management means is not provided here either. Such configurations are found for example in the so-called mobility sector in which relatively large fuel cells are installed which supply power to the vehicle and the drive. The battery only delivers the energy for the start of the system and of the fuel cell. While the fuel cell supplies power to the vehicle and the drive, the battery is recharged just like takes place using the generator in a conventional vehicle during operation. In this application, there is only one fuel cell and one battery. A plurality of identical supply systems are not provided here.

US 2001/018138 A1 discloses for example a system which operates a fuel cell at an operating point with high energy conversion efficiency. A control unit calculates the required power of an inverter.

In supply systems having a plurality of energy generators or suppliers of comparable capacity or having a plurality of identical components, an energy management system usually ensures that the load from the electrical network is uniformly distributed to the energy suppliers, such as, e.g., generators and/or batteries, installed in the electrical network. Such a system having a central controller is for example used in US 2016/297544 A1 to ensure the stability of an aircraft. If the energy is also generated by generators, this energy management means stops or starts the respective generators too depending on the load. In any case, it is impossible to manage without a superordinate energy management means. Particularly, if lithium accumulators are used. Overcharging the battery, which is quickly possible in components which have approximately the same size in terms of capacity, would considerably reduce the life of the battery or destroy the latter. In fuel cells, certain limits likewise need to be complied with in order not to reduce the life of the cell or destroy the fuel cell. Overload or feedback into the fuel cell thus likewise decreases the life thereof or destroys it. A superordinate energy management means has to be adapted in each case to match the type and the number of the respective components installed in the system.

### SUMMARY

Embodiments include an energy supply system having energy supply modules which are connected in parallel and each controlled autonomously, the energy supply modules each including load connections, a battery which couples directly to the load connections, a fuel cell which couples to the load connections via a DC/DC converter, characterized in that, within an energy supply module, an operating point of the fuel cell and an operating point of the DC/DC converter are able to be controlled by an energy management system on a basis of a state of charge of the battery.

Embodiments also include a method for supplying energy, in which a required base load can be provided by an energy supply system including energy supply modules which are connected in parallel and each controlled autonomously, wherein each energy supply module can provide energy both from a battery directly and from a fuel cell via a DC/DC converter, as well as from the battery and fuel cell together, characterized in that a state of charge of the battery is ascertained in each case and an operating point of the fuel cell or an operating point of the DC/DC converter is controlled on the basis of the state of charge of the battery.

### DETAILED DESCRIPTION

One object of the invention is to provide an energy supply system which allows an improved energy supply with regard to flexibility, reliability and life of the components. A further object of the invention is also to specify a corresponding method for supplying energy.

The invention achieves the object directed at an energy supply system in that it makes provision for the energy supply system to comprise energy supply modules which are independent of one another, autonomous in particular with regard to control and connected in parallel, the energy supply modules each comprising load connections, a battery which couples directly to the load connections, a fuel cell which couples to the load connections via a DC/DC converter, furthermore an energy management system with which the operating point of the fuel cell and the operating point of the DC/DC converter are able to be controlled on the basis of a state of charge of the battery.

In particular, for each energy supply module, the operating point of the fuel cell and the operating point of the DC/DC converter are able to be controlled exclusively on the basis of a state of charge of the battery.

The autonomous energy management system of each energy supply module of the energy supply system controls the operating point of the respective DC/DC converter such that, together with the respective battery, enough power is always available for a load.

At the same time, the energy management systems of the energy supply modules ensure that the state of charge of the respective battery only ever moves within determined limits. This process ensures the maximum life of all the components.

Advantageously, the energy supply modules each further comprise a bus system for the communication between the energy management system and a battery management system of an energy supply module, for the communication between the energy management system and a controller of the fuel cell of the energy supply module and for the communication between the energy management system and the DC/DC converter of the supply module. All the error messages, warnings, control values and data necessary for the operation of the energy supply module are transmitted between the energy management system and the individual components via this bus system.

The energy supply module therefore allows the construction of an energy supply system made up of one or more identical supply components which are autonomous with regard to control and independent of one another, without a superordinate control system being necessary to ensure the maximum life of the parts in the components.

The object directed at a method for supplying energy is achieved by a method in which a required base load can be provided by an energy supply system comprising energy supply modules which are connected in parallel and each controlled autonomously, wherein each energy supply module can provide energy both from a battery directly and from a fuel cell via a DC/DC converter, as well as from the battery and fuel cell together, wherein a state of charge of the battery is ascertained for each energy supply module and an operating point of the fuel cell or an operating point of the DC/DC converter is controlled on the basis of the state of charge of the battery.

As already explained with regard to the energy supply system, the operating point of the DC/DC converter is controlled in such a way that, together with the battery, enough power is always available for a load. In this case, according to the invention, the state of charge of the battery always moves within determined limits. This process ensures the maximum life of all the components.

Advantageously, transiently occurring peak loads are covered only by the battery because the battery has no waiting period until energy can be delivered, as would be the case for the fuel cell.

Moreover, it is advantageous if a state of charge of the battery only ever moves within determined limits. Each so-called deep discharge damages a battery. This damage typically accumulates. At the upper end of the state-of-charge scale too, however, care should be taken to ensure that the battery is not regularly charged to 100%. A state of charge of 80 to 90% is expedient as the upper limit here.

The two charging end points for the battery, both the lower charging end point SoCₘᵢₙ and the upper charging end point SoCₘₐₓ, are selected in such a way that the maximum life of the battery is achieved at the maximum usable capacity, and enough control reserve is available for the fuel cell.

It is likewise expedient if the operating point of the DC/DC converter is controlled in such a way that together with the battery enough power is always available. The operating point of the DC/DC converter can be used to set the total power of the energy supply module and the loading of its components in a simple manner.

It is advantageous if error messages, warnings, control values and data necessary for the method are transmitted via a bus system. It makes bidirectional operation possible and allows a plurality of components to be reliably connected to one another via the same set of lines.

It was already explained that discharging the battery too deeply should be avoided. It is therefore expedient that if it is determined that the state of charge of the battery (SoC) falls below a predefined threshold value SoCₘᵢₙ, the operating point of the DC/DC converter is increased until the battery switches to the charging state.

It is likewise expedient, if the battery switches from charging to discharging before it has reached its upper charging end point SoCₘₐₓ, that the operating point of the DC/DC converter is increased until the battery is recharged or the maximum output current of the fuel cell is reached.

Furthermore, it is expedient, when the battery is being charged, if the operating point of the DC/DC converter is set in such a way that a maximum permissible charging current in the battery is not exceeded. Otherwise the battery heats up too much and becomes damaged.

It is advantageous that, if the battery has reached the preset upper charging point SoCₘₐₓ, the operating point of the DC/DC converter is lowered until the current being drawn from the battery reaches a preset percentage of a permissible continuous discharge current of the battery and that a load is covered jointly by the fuel cell and the battery.

In one advantageous form of the configuration of the method according to the invention, if a load requirement does not change and the battery reaches its upper charging end value SoCₘₐₓ, the fuel cell is switched off and remains in stand-by mode until the SoC value of the battery gets close to the lower charging end value SoCₘᵢₙ and only then is the fuel cell restarted.

If a load decreases, it is expedient if the operating point of the DC/DC converter is lowered until a current from the battery has approximately reached the set percentage of a continuous discharge current again.

The operating point of the DC/DC converter and therefore also of the fuel cell is advantageously changed only if a new pending load is pending for longer than a settable dead time. This prevents a constant change or a swing in the operating point of the fuel cell. Additionally, the speed at which the DC/DC converter changes the operating point and therefore also the current from the fuel cell is limited by the specifications for the maximum permissible current change rates of the fuel cell. This method achieves further protection of the fuel cell and thus lengthens the life.

The output power of the fuel cell can also not be reduced arbitrarily since as a result the life is likewise negatively influenced. The permissible, permanent minimum load of the fuel cell P_{BZmin} is predefined by the manufacturer.

In order to protect the battery, it is expedient, if the maximum permissible long-term discharge current of the battery is reached or exceeded, if the operating point of the DC/DC converter is increased until the long-term discharge current falls below its maximum value again. The short-term discharge current of the battery is usually a multiple of the long-term discharge current, which is why short-term exceedances of the long-term discharge current or peak currents have no negative influence on the life of the battery.

If a single energy supply module cannot satisfy the required load alone, it is advantageous if a plurality of energy supply modules are connected in parallel. The energy supply system made up of a plurality of energy supply modules then consists of autonomous, identical components, without a superordinate energy supply system being required. If a plurality of these energy supply modules work in parallel in a network, all these energy supply modules behave identically, e.g. as parallel-connected batteries or controlled power supply units. All the involved energy supply modules supply power to the network on an equal basis.

If the parameters of the individual energy supply modules are not set identically, e.g. the SoCₘₐₓ of one system is set higher than in the other supply modules, it may be the case that energy is fed from the load system into the battery for a longer time and the battery is charged concomitantly by the load system. In this case, the operating point of the DC/DC converter is reduced to its minimum value. If even more energy is required from the system within this time, the operating point of the DC/DC converter changes in accordance with the method described previously.

If the load requirement from the system does not change and the battery reaches its upper charging end value, SoCₘₐₓ, the fuel cell is switched off. The fuel cell remains in stand-by mode until the SoC value of the battery gets close to the lower charging end value SoCₘᵢₙ. Only now is the fuel cell restarted. Since all the batteries are connected in parallel, all the batteries also have the same voltage level and more or less the same state of charge. Accordingly, all the supply systems in the network behave identically.

The energy supply system according to the invention having the energy supply modules and the corresponding method for energy management between the battery and fuel cell makes it possible to supply energy to a load system in the most effective way and at the same time to guarantee the maximum life of the components. The energy supply system and the corresponding method offer the following advantages:

The respective energy management means of each individual energy supply module ensures that none of the limit values of the individual parts in the supply component are exceeded and as a result the parts could be damaged.

The energy supply system behaves toward the load system just like any other energy supply system, only with a considerably greater capacity which is determined solely and exclusively by the number of the energy supply modules.

Since all the fast current changes which may occur in the system, e.g. while loads are being switched on or switched off, are supported by the battery, no soft-start circuits or parts for limiting the inrush currents are necessary in the load system.

The base load is delivered by the two components, that is to say by the battery and by the fuel cell. Oversizing of the battery is not necessary.

If required, the fuel cell ensures that the battery is also charged along with the network supply. In this case, the energy management system makes sure that the maximum charging current of the battery is not exceeded.

The energy management means prevents the fuel cell having to change its power too often and too quickly, which has a negative impact on the life of the fuel cell.

Due to the fact that all the supply components are identical, the manufacturing can be simplified. An energy supply module only ever has to have the same size, and always be built with the same parts, no matter what size the load system actually has. I.e., there is hardly any construction effort for new arrangements.

All combinations of battery and fuel cell work autonomously.

Any number of these combinations can be connected together in parallel without there having to be a superordinate control system which has to be adapted to match the respective arrangement.

A high redundancy is achieved and a high flexibility is achieved at low manufacturing costs.

### BRIEF DESCRIPTION OF THE DRAWINGS

The invention will now be explained in more detail by way of example with reference to the drawings. In the figures which are schematic and not to scale:

FIG. 1 shows an energy supply module of an energy supply system according to the invention,

FIG. 2 shows an energy supply system comprising a plurality of energy supply modules, and

FIG. 3 shows time characteristics of the fuel cell power and of the battery state of charge as a function of a load requirement.

### DETAILED DESCRIPTION OF THE DRAWINGS

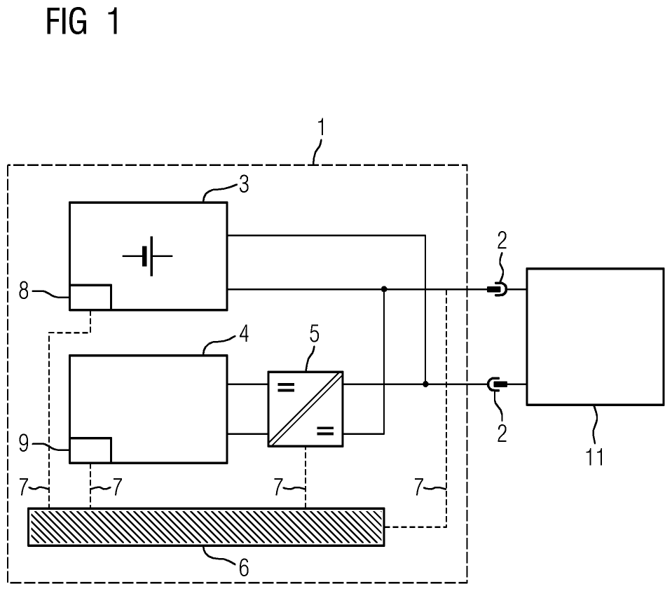

FIG. 1 shows, schematically and by way of example, an energy supply module 1 of an energy supply system 10 according to the invention, which is coupled to a load 11. The energy supply module 1 comprises load connections 2, a battery 3 which couples directly to the load connections 2, a fuel cell 4 which couples to the load connections 2 via a DC/DC converter 5, and an energy management system 6 with which the operating point of the fuel cell 4 and the operating point of the DC/DC converter 5 are able to be controlled on the basis of a state of charge of the battery 3. The control takes place via a bus system 7 which ensures the communication between the energy management system 6 and a battery management system 8, the communication between the energy management system 6 and a controller 9 of the fuel cell 4 and the communication between the energy management system 6 and the DC/DC converter 5. All of the error messages, warnings, control values and data necessary for the method, such as, e.g., from the current measurement at the load connections 2, are transmitted via this bus system 7.

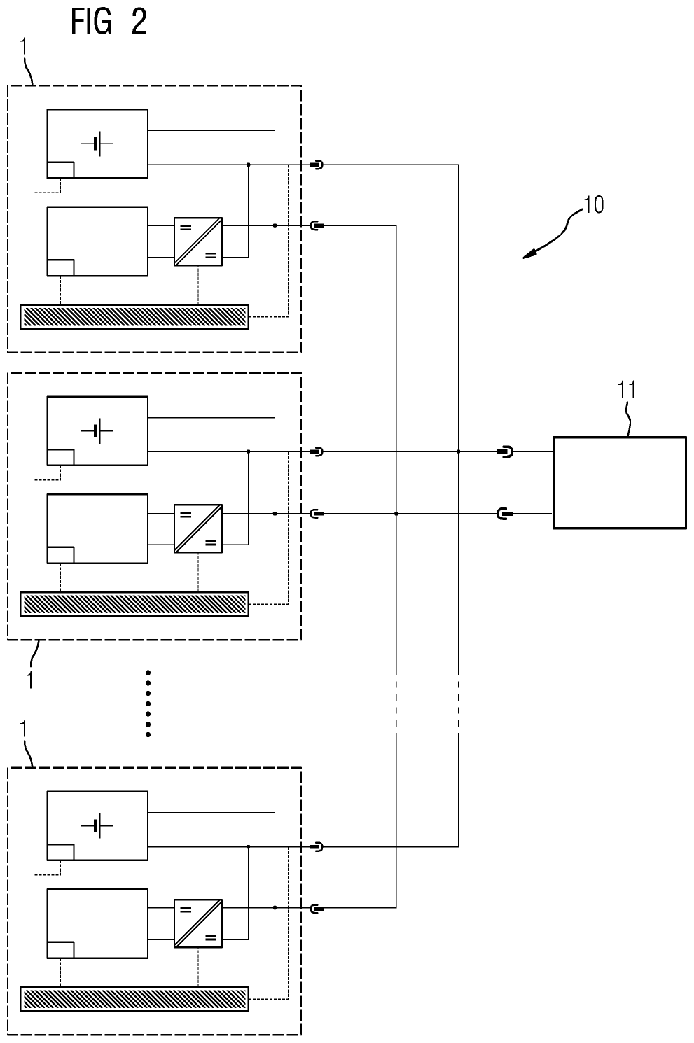

FIG. 2 shows an energy supply system 10 according to the invention. It comprises energy supply modules 1 which are independent of one another with regard to control and connected in parallel.

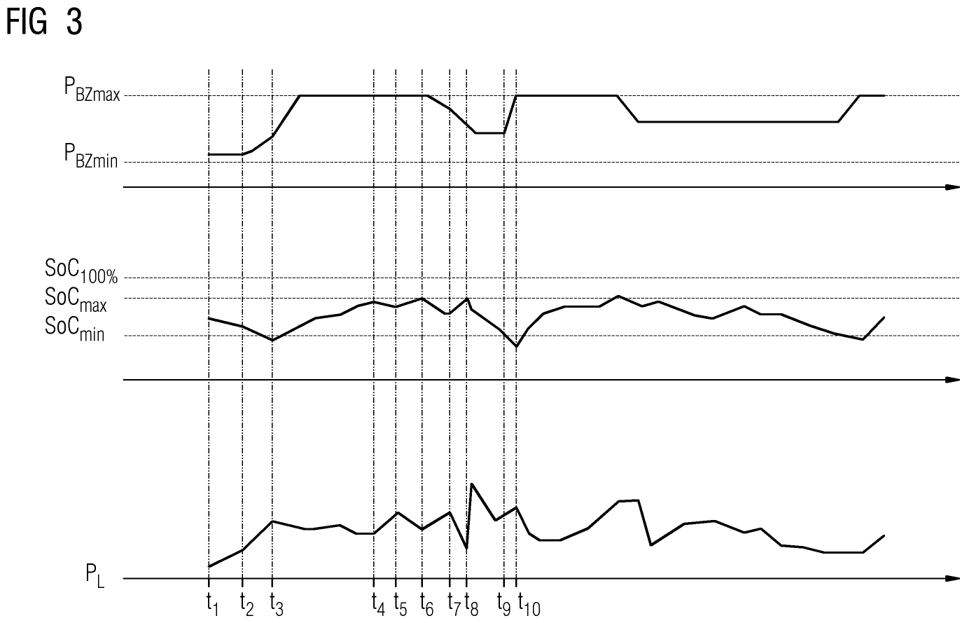

FIG. 3, in the lower part, shows by way of example a time characteristic of a load requirement P_{L}.

Directly above it, in the middle of FIG. 3, a battery state of charge is illustrated. For the state of charge of the battery, the three most important values are plotted: full state of charge SoC_{100%}, ideal maximum state of charge for the life of the battery SoCₘₐₓ and recommended minimum state of charge SoCₘᵢₙ. The state of charge SoC of the battery 3 always moves essentially within the determined limits SoCₘₐₓ and SoCₘᵢₙ. Falling below SoCₘᵢₙ for a short time is acceptable in this case.

Above the battery state of charge, a corresponding fuel cell power P_{BZ} is illustrated in FIG. 3. The characteristic of the fuel cell power lies between a maximum fuel cell power P_{BZmax} and a minimum fuel cell power P_{BZmin}.

The behavior of an energy supply module 1 at different load states or load developments is explained in more detail below with reference to the characteristics shown in FIG. 3.

From time t₈, the curve profiles show an example of transiently occurring peak loads being covered only by the battery 3. Generally, the operating point of the DC/DC converter 5 is controlled in such a way that together with the battery 3 enough power is always available.

At time t₃, it is determined that the state of charge of the battery (SoC) falls below the predefined threshold value SoCₘᵢₙ. Consequently, the operating point of the DC/DC converter 5 is increased and the battery 3 switches into the charging state. The state of charge of the battery (SoC) also falls below the predefined threshold value SoCₘᵢₙ at time t₉. However, the load requirement here increases comparatively quickly, with the result that the fuel cell 4 can no longer provide enough energy alone. The battery state of charge therefore falls below the lower limit SoCₘᵢₙ for a short time until at time t₁₀ the load requirement falls and the power that is able to be provided by the fuel cell 4 is sufficiently high both to cover the power demand of the load 11 and to recharge the battery 3.

At time t₄, the battery 3 switches from charging to discharging, namely before it has reached its upper charging end point SoCₘₐₓ. If the maximum output current of the fuel cell 4 has still not been reached, the operating point of the DC/DC converter 5 is increased until the battery 3 is recharged or the maximum output current of the fuel cell 4 is reached. In the example of FIG. 3, at time t₄, the fuel cell already runs at the maximum, which is why nothing else is changed at the operating point of the DC/DC converter. However, at time t₅, at which the load requirement begins to fall, the operating point is maintained and the battery 3 is charged until SoCₘₐₓ is reached at time t₆.

Generally, when the battery 3 is being charged the operating point of the DC/DC converter 5 is set in such a way that a maximum permissible charging current in the battery 3 is not exceeded. This can be seen for example at time t₇, where the battery 3 is being charged but this does not take place at maximum power of the fuel cell 4.

If the battery 3 has reached the preset upper charging point SoCₘₐₓ, for example at time t₆, the operating point of the DC/DC converter 5 is lowered until the current being drawn from the battery 3 reaches a preset percentage of a permissible continuous discharge current of the battery 3 and a load is covered jointly by the fuel cell 4 and the battery 3.

Alternatively, if a load requirement does not change and the battery 3 reaches its upper charging end value SoCₘₐₓ, the fuel cell 4 could be switched off and remain in stand-by mode until the SoC value of the battery 3 gets close to the lower charging end value SoCₘᵢₙ and only then would the fuel cell 4 be restarted.

Lowering the operating point of the DC/DC converter 5 is also useful in order that, when the load decreases, the current from the battery 3 approximately reaches the set percentage of a continuous discharge current again.

It can also be seen from FIG. 3 that the operating point of the DC/DC converter 5 and therefore also of the fuel cell 4 is changed only if a new pending load is pending for longer than a settable dead time. At time t₆, for example, the load begins to rise but only the state of charge of the battery 3 follows instantaneously; a change in the fuel cell power is delayed.

Finally, it can be seen from FIG. 3 that, if the maximum permissible long-term discharge current of the battery 3 is reached or exceeded, the operating point of the DC/DC converter 5 is increased until the long-term discharge current falls below its maximum value again. This is shown on the curve profile in the region of the times t₁, t₂ and t₃. At point t₂, the gradient of the load requirement increases, the state of charge of the battery 3 falls more quickly and the power curve of the fuel cell 4 switches from a sideward movement to a rise.

1. An energy supply system comprising energy supply modules which are connected in parallel and each controlled autonomously, the energy supply modules each comprising load connections, a battery which couples directly to the load connections, a fuel cell which couples to the load connections via a DC/DC converter, characterized in that, within an energy supply module, the an operating point of the fuel cell and an operating point of the DC/DC converter are able to be controlled by an energy management system on a basis of a state of charge of the battery.

2. The energy supply system as claimed in claim 1, wherein the energy supply modules each comprise a bus system for a communication between the energy management system and a battery management system, for the communication between the energy management system and a controller of the fuel cell and for the communication between the energy management system and the DC/DC converter.

3. A method for supplying energy, in which a required base load can be provided by an energy supply system comprising energy supply modules which are connected in parallel and each controlled autonomously, wherein each energy supply module can provide energy both from a battery directly and from a fuel cell via a DC/DC converter, as well as from the battery and fuel cell together, characterized in that a state of charge of the battery is ascertained in each case and an operating point of the fuel cell or an operating point of the DC/DC converter is controlled on the basis of the state of charge of the battery.

4. The method as claimed in claim 3, wherein transiently occurring peak loads are covered only by the battery.

5. The method as claimed in claim 3, wherein a state of charge of the battery moves essentially within determined limits.

6. The method as claimed in claim 3, wherein the operating point of the DC/DC converter is controlled in such a way that together with the battery enough power is always available.

7. The method as claimed in claim 3, wherein error messages, warnings, control values and data necessary for the method are transmitted via a bus system.

8. The method as claimed in claim 3, wherein if it is determined that the state of charge of the battery (SoC) falls below a predefined threshold value SoCₘᵢₙ, the operating point of the DC/DC converter is increased until the battery switches to the charging state.

9. The method as claimed in claim 3, wherein if the battery switches from charging to discharging before it has reached its upper charging end point SoCₘₐₓ, the operating point of the DC/DC converter is increased until the battery is recharged or the maximum output current of the fuel cell is reached.

10. The method as claimed in claim 3, wherein when the battery is being charged the operating point of the DC/DC converter is set in such a way that a maximum permissible charging current in the battery is not exceeded.

11. The method as claimed in claim 3, wherein if the battery has reached a preset upper charging point SoCₘₐₓ, the operating point of the DC/DC converter is lowered until the current being drawn from the battery reaches a preset percentage of a permissible continuous discharge current of the battery and a load is covered jointly by the fuel cell and the battery.

12. The method as claimed in claim 3, wherein if a load requirement does not change and the battery reaches its upper charging end value SoCₘₐₓ, the fuel cell is switched off and remains in stand-by mode until the SoC value of the battery gets close to the lower charging end value SoCₘᵢₙ and only then is the fuel cell restarted.

13. The method as claimed in claim 3, wherein if a load decreases, the operating point of the DC/DC converter is lowered until a current from the battery has approximately reached a set percentage of a continuous discharge current again.

14. The method as claimed in claim 3, wherein the operating point of the DC/DC converter and therefore also of the fuel cell is changed only if a new pending load is pending for longer than a settable dead time.
